(19) United States
(12) Patent Application Publication
(10) Pub. No.: US 2025/0378679 A1
(43) Pub. Date: Dec. 11, 2025

(54) TRAINED MODEL GENERATION DEVICE, INFORMATION PROCESSING DEVICE, TRAINED MODEL GENERATION METHOD, INFORMATION PROCESSING METHOD, RECORDING MEDIUM IN WHICH TRAINED MODEL GENERATION PROGRAM IS RECORDED, AND RECORDING MEDIUM IN WHICH INFORMATION PROCESSING PROGRAM IS RECORDED

(71) Applicants: General Incorporated Association Wellness Meister Association, Tokyo (JP); M.M.E. Co., Ltd., Yamaguchi (JP); IoYou Inc., Yamaguchi (JP)

(72) Inventors: Masaru SUZUKI, Yamaguchi (JP); Yukihisa NAMIKI, Yamaguchi (JP); Mitsuo NUMATA, Yamaguchi (JP); Kazuyoshi HATA, Tokyo (JP); Masashi TAKEMOTO, Tokyo (JP)

(21) Appl. No.: 19/229,413

(22) Filed: Jun. 5, 2025

(30) Foreign Application Priority Data
Jun. 7, 2024 (JP) 2024-093213

(51) Int. Cl. G06V 10/774; G06V 10/764

(52) U.S. Cl. CPC G06V 10/774; G06V 10/764

(57) ABSTRACT

An information processing device acquires plural learning images in which a subject that is a part of each of individuals or species appears, the plural learning images being captured for each of the individual or species. The information processing device trains a learning model such that a probability of the same shape category is the highest in a case in which learning images in which the subjects of the same individual or species appear are input to the learning model. The information processing device generates the trained model by training the learning model so as to increase a variance of a probability distribution output from the learning model in a case in which each of learning images in which the subjects of plural different individuals or species appear is input to the learning model.

### CROSS-REFERENCE TO RELATED APPLICATION

This application is based on and claims priority under 35 USC 119 from Japanese Patent Application No. 2024-093213 filed on Jun. 7, 2024, the disclosure of which is incorporated by reference herein.

### BACKGROUND

### Technical Field

A technique of the present disclosure relates to a trained model generation device, an information processing device, a trained model generation method, an information processing method, a recording medium in which a trained model generation program is recorded, and a recording medium in which an information processing program is recorded.

### Related Art

Chinese Patent Application Publication No. 1932848 discloses a method of classifying a shape of a tongue with a computer. Specifically, Chinese Patent Application Publication No. 1932848 discloses a technique of acquiring 120 peripheral points from a tongue image by a snake operation, performing equalization processing of the peripheral points and deflection correction processing of a tongue shape, and identifying the tongue shape.

Chinese Patent Application Publication No. 110363073 discloses a tongue-shaped object recognition method. Specifically, Chinese Patent Application Publication No. 110363073 discloses a convolutional neural network as a tongue-shaped object identification model, and discloses that tongue segmentation is executed using the convolutional neural network.

Chinese Patent Application Publication No. 111582113 discloses a tongue shape identification method based on image processing. Specifically, Chinese Patent Application Publication No. 111582113 discloses a technique of executing gray processing on a tongue body image based on an HSV color space model obtained in advance to acquire a binary tongue body image, executing boundary delineation on the binary tongue body image to acquire a tongue image boundary, and executing tongue shape identification on the tongue image boundary.

Chinese Patent Application Publication No. 113177499 discloses a tongue crack shape identification method based on computer vision. Specifically, Chinese Patent Application Publication No. 113177499 discloses a technique of detecting and marking a tongue crack, and identifying and marking a shape of the tongue crack.

Meanwhile, a shape of a tongue is also said to be a genetic trait. Note that there are body parts that are said to be genetic traits other than the tongue. If it is possible to classify shapes of body parts that are genetic traits, an application to, for example, classification of a disease state in medical care is possible. Therefore, it is considered that a technique for classifying shapes of body parts is useful.

In addition, a technique for classifying shapes of various subjects as well as body parts is useful. As a method for classifying a shape of a subject, for example, a method is considered in which a person determines in advance which shape category among a plurality of shape categories the shape of the subject belongs to and a trained model is generated using the determination result as learning data. In this case, for example, when an image in which the subject appears is input to the trained model, a probability of the shape category to which the subject belongs is output from the trained model.

However, there is a case in which a person cannot determine in advance a shape category to which a subject for learning belongs. For example, whether or not a certain subject and another subject belong to the same shape category is subtle, and it is sometimes difficult for the person to make the determination.

Therefore, in a case in which it is difficult for the person to determine the shape category to which the subject for learning belongs, there is a problem that it is also difficult to classify a shape of the subject as a target.

A technique of the disclosure has been made in view of the above circumstances, and provides a trained model generation device, an information processing device, a trained model generation method, an information processing method, a recording medium in which a trained model generation program is recorded, and a recording medium in which an information processing program is recorded, which are capable of classifying a shape of a subject as a target even when it is difficult for a person to determine a shape category to which the subject belongs.

### SUMMARY

In order to achieve the above object, a first aspect of the disclosure is a trained model generation device including: a learning acquisition unit that acquires a plurality of learning images in which a subject that is a part of each of individuals or species appears, the plurality of learning images being captured for each of the individuals or species; and a trained model generation unit that trains a learning model by machine learning based on the plurality of learning images to generate a trained model that outputs a probability of a shape category to which the subject belongs in response to an input of an image in which the subject appears, the trained model being generated by training the learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

A second aspect of the disclosure is a trained model generation method causing a computer to execute processing, the processing including: acquiring a plurality of learning images in which a subject that is a part of each of individuals or species appears, the plurality of learning images being captured for each of the individuals or species; and training a learning model by machine learning based on the plurality of learning images to generate a trained model that outputs a probability of a shape category to which the subject belongs in response to an input of an image in which the subject appears, the trained model being generated by training the learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

A third aspect of the disclosure is a recording medium in which a trained model generation program for causing a computer to execute processing is recorded, the processing including: acquiring a plurality of learning images in which a subject that is a part of each of individuals or species appears, the plurality of learning images being captured for each of the individuals or species; and training a learning model by machine learning based on the plurality of learning images to generate a trained model that outputs a probability of a shape category to which the subject belongs in response to an input of an image in which the subject appears, the trained model being generated by training the learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

A fourth aspect of the disclosure is an information processing device including: an acquisition unit that acquires an image in which a subject appears as a target; and a specification unit that inputs the image acquired by the acquisition unit to a trained model generated in advance to acquire probabilities of shape categories output from the trained model, and specifies a shape category to which the subject appearing in the image belongs using the probabilities, wherein the trained model is the trained model that outputs a probability of the shape category to which the subject appearing in the image belongs in response to the input of the image in which the subject appears, and the trained model is the trained model obtained by training a learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

A fifth aspect of the disclosure is an information processing method causing a computer to execute processing, the processing including: acquiring an image in which a subject appears as a target; and inputting the acquired image to a trained model generated in advance to acquire probabilities of shape categories output from the trained model, and specifying a shape category to which the subject appearing in the image belongs using the probabilities, wherein the trained model is the trained model that outputs a probability of the shape category to which the subject appearing in the image belongs in response to the input of the image in which the subject appears, and the trained model is the trained model obtained by training a learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

A sixth aspect of the disclosure is a recording medium in which an information processing program for causing a computer to execute processing is recorded, the processing including: acquiring an image in which a subject appears as a target; and inputting the acquired image to a trained model generated in advance to acquire probabilities of shape categories output from the trained model, and specifying a shape category to which the subject appearing in the image belongs using the probabilities, wherein the trained model is the trained model that outputs a probability of the shape category to which the subject appearing in the image belongs in response to the input of the image in which the subject appears, and the trained model is the trained model obtained by training a learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

According to the technique of the disclosure, it is possible to classify the shape of the subject as the target even when it is difficult for the person to determine the shape category to which the subject belongs.

### BRIEF DESCRIPTION OF THE DRAWINGS

FIG. 1 is a diagram illustrating an example of a schematic configuration of an information processing device of an embodiment;

FIG. 2 is a view for describing pre-processing;

FIG. 3 is a view for describing a trained model;

FIG. 4 is a view for describing a probability distribution output from the trained model;

FIG. 5 is a view for describing cross-entropy;

FIG. 6 is a view for describing control of the number of categories;

FIG. 7 is a diagram illustrating an example of a computer included in the information processing device;

FIG. 8 is a view illustrating an example of pre-processing executed by the information processing device of the embodiment;

FIG. 9 is a view illustrating an example of trained model generation processing executed by the information processing device of the embodiment;

FIG. 10 is a view illustrating an example of information processing executed by the information processing device of the embodiment; and

FIG. 11 is a view illustrating results of Examples.

### DETAILED DESCRIPTION

Hereinafter, embodiments of the technique of the disclosure will be described in detail with reference to the drawings.

### Information Processing Device of Embodiment

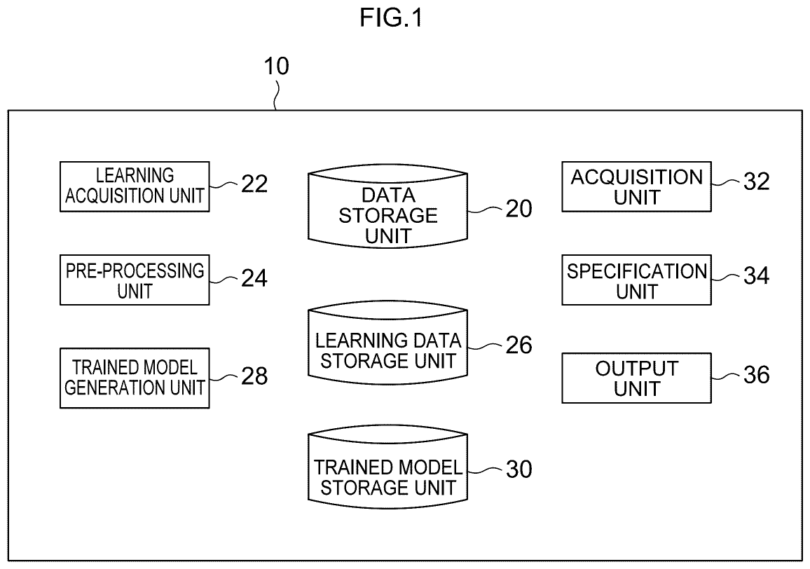

FIG. 1 illustrates an information processing device 10 according to an embodiment. As illustrated in FIG. 1, the information processing device 10 functionally includes a data storage unit 20, a learning acquisition unit 22, a pre-processing unit 24, a learning data storage unit 26, a trained model generation unit 28, a trained model storage unit 30, an acquisition unit 32, a specification unit 34, and an output unit 36. The information processing device 10 is implemented by a computer as described later.

The information processing device 10 of the present embodiment classifies a shape (or contour) of a tongue using a machine learning model. Hereinafter, description will be given in detail. In the present embodiment, a case in which a subject that is a part of an individual or a species is a tongue will be described as an example. In addition, a case in which a test subject corresponds to the individual or the species will be described as an example in the present embodiment.

The data storage unit 20 stores a plurality of learning images in which a tongue of each test subject appears. The learning image is an image of the tongue captured for each test subject.

The learning acquisition unit 22 reads the plurality of learning images stored in the data storage unit 20 to acquire the plurality of learning images.

The pre-processing unit 24 executes pre-processing on each of the plurality of learning images acquired by the learning acquisition unit 22 using a known method.

Specifically, the pre-processing unit 24 first extracts a tongue region from the learning image using a known image processing method. For example, the pre-processing unit 24 extracts the tongue region from the learning image using a trained model for tongue region extraction that outputs 1 for the tongue region and outputs 0 for a region different from the tongue region with respect to the input image. Note that this trained model for tongue region extraction can be constructed by a known machine learning technique.

Next, the pre-processing unit 24 removes noise in the image in which the tongue region has been extracted using a known image processing method. Then, the pre-processing unit 24 corrects an inclination of the tongue region appearing in the image using a known image processing method. Specifically, the pre-processing unit 24 calculates an angle at which the left-right symmetry of the tongue region is the highest and rotates the tongue region according to the calculated angle.

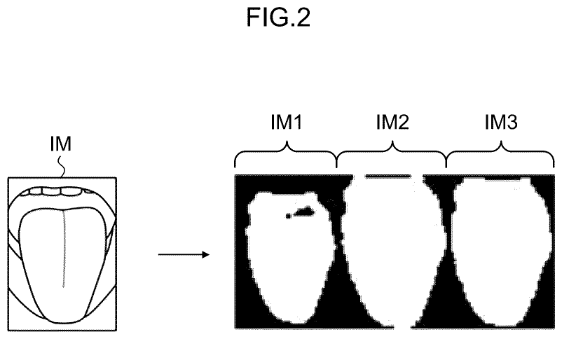

FIG. 2 is a view for describing pre-processing. As illustrated in FIG. 2, the pre-processing unit 24 first extracts a tongue region from a learning image IM using a known image processing method, and generates an image IM1 in which the tongue region is extracted. Next, the pre-processing unit 24 removes noise from the image IM1 in which the tongue region is extracted using a known image processing method. As illustrated in FIG. 2, noise is removed from the image IM1 in which the tongue region is extracted, whereby an image IM2 is generated. Then, the pre-processing unit 24 adjusts an angle of the image IM2 from which the noise has been removed, thereby generating an image IM3 in which the tongue region appears.

The learning data storage unit 26 stores a plurality of pre-processed learning images pre-processed by the pre-processing unit 24.

The trained model generation unit 28 trains a learning model by unsupervised machine learning based on the plurality of pre-processed learning images stored in the learning data storage unit 26, thereby generating a trained model that outputs probabilities of shape categories to which a tongue belongs in reception of an input of an image in which the tongue appears. Note that the trained model is, for example, a known neural network model.

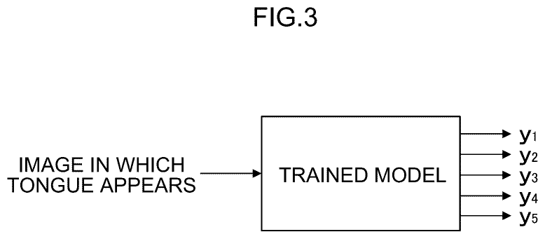

FIG. 3 is a view for describing the trained model of the present embodiment. As illustrated in FIG. 3, when an image in which a tongue appears is input to the trained model of the present embodiment, probabilities y of belonging of the tongue appearing in the image are output. In an example of FIG. 3, five shape categories are set, and a probability y₁ that the tongue appearing in the image belongs to a shape category 1, a probability y₂ that the tongue belongs to a shape category 2, a probability y₃ that the tongue belongs to a shape category 3, a probability y₄ that the tongue belongs to a shape category 4, and a probability y₅ that the tongue belongs to a shape category 5 are output. Note that a sum of the probability y₁, the probability y₂, the probability y₃, the probability y₄, and the probability y₅ is adjusted by a known softmax function so as to be 1.

Note that the trained model generation unit 28 trains the learning model such that a probability of the same shape category is the highest in a case in which learning images of the same test subject are input to the learning model at the time of generating the trained model as illustrated in FIG. 3. In addition, the trained model generation unit 28 trains the learning model such that a variance of a probability distribution output from the learning model increases in a case in which each of a plurality of learning images of different test subjects is input to the learning model at the time of generating the trained model.

More specifically, the trained model generation unit 28 generates the trained model by training the learning model so as to decrease first entropy indicated by the following Formula (A) and related to a probability yᵢ of an i-th shape category output from the learning model. The following Formula (A) is a loss function for maximizing a probability of a single shape category without dispersing a probability distribution output from the trained model so much when a certain image is input to the trained model.

$$\begin{matrix}[ Mathematical Expression 1 ] & \\ - {\sum }_{i} {y}_{i} ln {y}_{i} & ( A )\end{matrix}$$

In addition, the trained model generation unit 28 generates the trained model by training the learning model so as to decrease second entropy, which is indicated by the following Formula (B) and is cross-entropy between the probability yᵢ of the i-th shape category output when a first learning image of a first test subject, who is a certain test subject, is input to the learning model and a probability yᵢ' of the i-th shape category output when a second learning image, which is another image of the first test subject, is input to the learning model. The following Formula (B) is a loss function for maximizing a probability of the same shape category in a case in which two images obtained from the same test subject are input to the trained model.

$$\begin{matrix}[ Mathematical Expression 2 ] & \\ - {\sum }_{i} {{y}_{i}}^{′} ln {y}_{i} & ( B )\end{matrix}$$

In addition, the trained model generation unit 28 generates the trained model by training the learning model so as to increase third entropy indicated by the following Formula (C) and related to a sample average <yᵢ>of the probability yᵢ of the i-th shape category output when each of the plurality of learning images is input to the learning model. The following Formula (C) is a loss function for increasing a variance of a probability distribution output from the trained model in a case in which each of images obtained from a plurality of different test subjects is input to the trained model. This is because the respective images of tongues of the plurality of test subjects have various shapes, and it is estimated that shape categories to which the tongues belong are also dispersed.

$$\begin{matrix}[ Mathematical Expression 3 ] & \\ - {\sum }_{i} 〈 {y}_{i} 〉 ln 〈 {y}_{i} 〉 & ( C )\end{matrix}$$

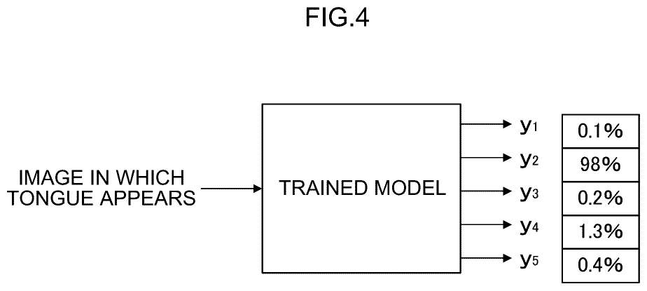

FIG. 4 is a view for describing a probability distribution output from the trained model. As illustrated in FIG. 4, when a certain pre-processed learning image is input to the trained model, the trained model generation unit 28 trains the learning model such that a probability for one shape category is high and probabilities of the other shape categories are low. In an example of FIG. 4, when a certain image is input to the trained model, the probability y₂ of the shape category 2 is 98%, and the probabilities of the other shape categories are low. In order to achieve such a state, the trained model generation unit 28 generates the trained model by training the learning model so as to decrease the first entropy related to the probability yᵢ of the i-th shape category output from the learning model and indicated in the above Formula (A). As a result, when a certain image is input to the trained model, it is possible to prevent a probability output from the trained model from being dispersed, and it is possible to achieve a state where the input image belongs to a specific single shape category.

In addition, the trained model generation unit 28 generates the trained model by training the learning model so as to decrease the second entropy indicated in the above Formula (B). The second entropy indicated in the above Formula (B) is cross-entropy between a set {yᵢ} of probabilities when first learning images of a first test subject who is a certain test subject are input to the trained model and a set {yᵢ'} of probabilities when second learning images of the first test subject are input to the trained model.

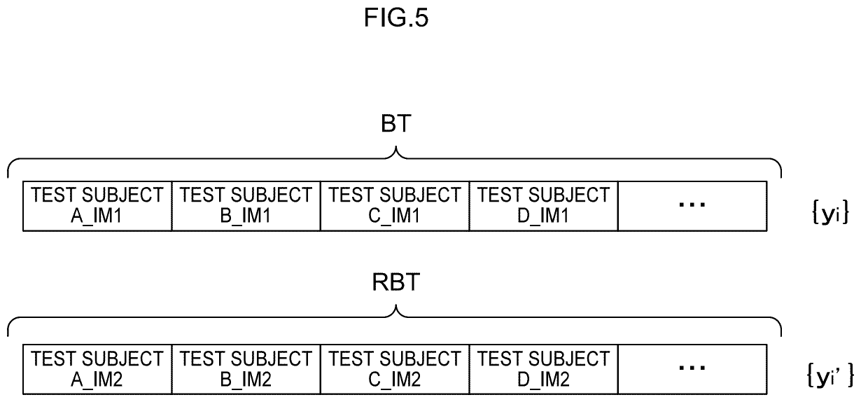

FIG. 5 is a view for describing the cross-entropy. In the present embodiment, as illustrated in FIG. 5, the mini-batch BT is set by selecting an image set from a plurality of pre-processed learning images. In addition, an image set different from the mini-batch BT is selected from the plurality of pre-processed learning images and set as the reference batch RBT. At this time, the reference batch RBT is configured to include different images from the mini-batch BT and include the same combination of test subjects as those of the mini-batch BT.

In this case, it is assumed that a set {yᵢ} of output probabilities when a plurality of pre-processed learning images included in a mini-batch BT are input to the learning model is obtained. In addition, it is assumed that a set {yᵢ'} of output probabilities when a plurality of pre-processed learning images included in a reference batch RBT are input to the learning model is obtained.

In this case, the trained model generation unit 28 trains the learning model so as to minimize the second entropy, which is the cross-entropy between the set {yᵢ} of output probabilities corresponding to the mini-batch BT and the set {yᵢ'} of output probabilities corresponding to the reference batch RBT. For example, in a case in which the probability of the shape category 2 is the maximum when an image of a tongue of a certain test subject A is input to the trained model, the learning model is trained such that the probability of the shape category 2 is similarly maximized when an image of the tongue of the test subject A captured on another day is input to the trained model. Since the trained model is generated so as to decrease the second entropy, the probability of the same shape category is maximized when images of the same test subject are input to the trained model.

In addition, the trained model generation unit 28 generates the trained model by training the learning model so as to increase the third entropy indicated in the above Formula (C). As a result, it is possible to make shape categories to which learning images of a plurality of test subjects belong as many as possible. As a result, it is possible to widely disperse the shape categories of tongues.

In a case in which the above Formulas (A), (B), and (C) are integrated, it is possible to set a loss function L indicated by the following Formula (D1).

$$\begin{matrix}[ Mathematical Expression 4 ] & \\ L = {〈 - {\sum }_{i} ( {y}_{i} + {{y}^{′}}_{i} ) ln {y}_{i} 〉}_{b} + ( - ln ( 1 / n ) + {\sum }_{i} {〈 {y}_{i} 〉}_{b} ln {〈 {y}_{i} 〉}_{b} ) & ( D1 )\end{matrix}$$

In the above Formula (D1), b represents a mini-batch that is an image set selected from a plurality of learning images, <>_{b} represents a sample average of probabilities of shape categories of learning images included in the mini-batch, and n represents the number of shape categories. For example, when the number of shape categories is 5, n=5.

As described above, the trained model configured to disperse the shape categories to which the learning images of the plurality of test subjects belong as much as possible is obtained by training the learning model so as to increase the third entropy indicated in the above Formula (C).

In learning using the above Formula (D1), the learning proceeds such that distribution at a rate of 1/n is performed equally to all categories. However, there is a case in which a state where the frequency of each category varies is appropriate. In this case, classification with variations in the frequency among categories is implemented by converging a value of the term of the above Formula (C) to a value 0 in the case of being distributed to a single category and to an intermediate value −εln(1/n) of a maximum value −ln(1/n) in the case of being equally distributed to all the categories by 1/n. ε is given in a range of ε∈[0, 1]. Based on this, the definition of a loss function obtained by changing Formula (D1) so as not to contribute when the value of the term of Formula (C) exceeds −εln(1/n) is described as Formula (D2). An optimum value of ε needs to be separately determined. For example, in a problem of the tongue, it is conceivable to select & that minimizes the rate at which an image group of the same test subject is classified over a plurality of categories in verification data after learning.

$$\begin{matrix}[ Mathematical Expression 5 ] & \\ L = {〈 - {\sum }_{i} ( {y}_{i} + {{y}^{′}}_{i} ) ln {y}_{i} 〉}_{b} + max ( - εln ( 1 / n ) + {\sum }_{i} {〈 {y}_{i} 〉}_{b} ln {〈 {y}_{i} 〉}_{b} , 0 ) & ( D2 )\end{matrix}$$

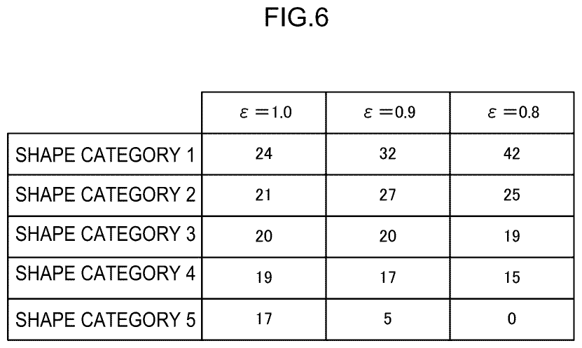

FIG. 6 is a view for describing control of the number of shape categories. Each of numbers illustrated in FIG. 6 represents the number of test subjects belonging to each shape category. For example, the shape category 1 when the parameter ε=1.0 is 24. This indicates that the number of test subjects with which the probability of the shape category 1 is maximized was 24 when the parameter ε=1.0. As illustrated in FIG. 6, when the parameter ε is set to be large, the trained model that disperses a plurality of test subjects into many shape categories is generated. On the other hand, a variance of the shape categories is suppressed when the parameter ε is set to be small. For example, when the parameter ε=0.8, the tongue belonging to the shape category 5 is 0, and thus the presence of the shape category 5 is unnecessary. In such a case, a procedure is taken to reduce the number of nodes in a final layer of the trained model to 4 or the like. The number of shape categories is set in advance by a user through such processing.

In the present embodiment, the trained model generation unit 28 generates the trained model by training the learning model so as to minimize the loss function L indicated in the above Formula (D2). Although the case in which the learning model is trained such that the loss function L indicated in the above Formula (D2) is minimized is described as an example in the present embodiment, the learning model may be trained such that the loss function L indicated in the above Formula (D1) is minimized. In addition, the learning model may be trained such that the respective loss functions of the above Formulas (A), (B), and (C) are minimized.

The trained model generated by the trained model generation unit 28 is stored in the trained model storage unit 30.

The acquisition unit 32 acquires an image in which a tongue appears as a target. Note that this image is an image different from the above-described learning image, and is an image of a target for specifying a shape category.

The specification unit 34 performs the same pre-processing as that of the pre-processing unit 24 on the image acquired by the acquisition unit 32. Then, the specification unit 34 inputs the pre-processed image to the trained model stored in the trained model storage unit 30 to acquire probabilities of shape categories output from the trained model. The specification unit 34 specifies a shape category to which the tongue appearing in the image belongs using the probabilities of the shape categories. For example, the specification unit 34 specifies a shape category having the highest probability out of a distribution of the probabilities of the shape categories as the shape category to which the tongue appearing in the image belongs.

The output unit 36 outputs the shape category specified by the specification unit 34 as a result.

The user who operates the information processing device 10 confirms the output result and confirms the shape category of the tongue appearing in the image.

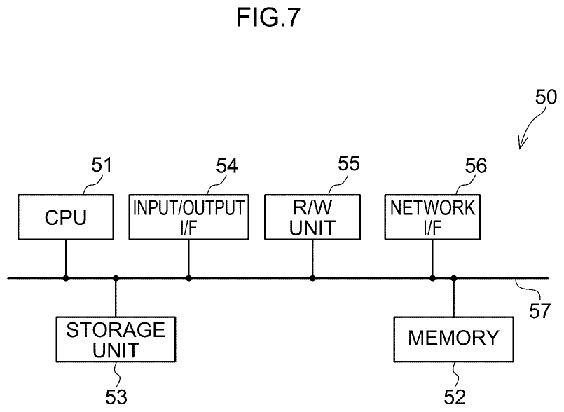

The information processing device 10 can be implemented by, for example, a computer 50 illustrated in FIG. 7. The computer 50 includes a CPU 51, a memory 52 as a temporary storage area, and a non-volatile storage unit 53. In addition, the computer 50 includes an input/output interface (I/F) 54 to which an external device, an output device, and the like are connected, and a read/write (R/W) unit 55 that controls reading and writing of data with respect to a recording medium. In addition, the computer 50 includes a network I/F 56 connected to a network such as the Internet. The CPU 51, the memory 52, the storage unit 53, the input/output I/F 54, the R/W unit 55, and the network I/F 56 are connected to each other via a bus 57.

The storage unit 53 can be implemented by a hard disk drive (HDD), a solid state drive (SSD), a flash memory, or the like. The storage unit 53 as a storage medium stores a program for causing the computer 50 to function. The CPU 51 reads the program from the storage unit 53, develops the read program in the memory 52, and sequentially executes processes included in the program.

### Operation of Information Processing Device of Embodiment

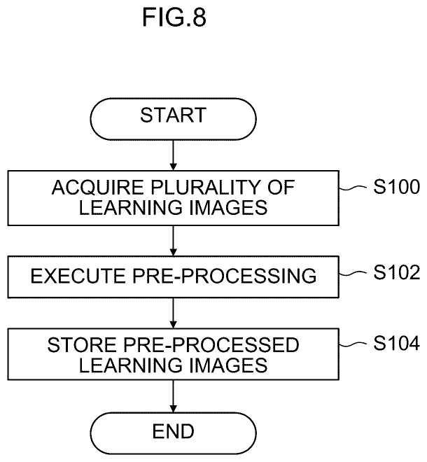

Next, a specific operation of the information processing device 10 of the embodiment will be described. The information processing device 10 executes pre-processing illustrated in FIG. 8.

In step S100, the learning acquisition unit 22 first reads a plurality of learning images stored in the data storage unit 20 to acquire the plurality of learning images.

In step S102, the pre-processing unit 24 executes the pre-processing described above on each of the plurality of learning images acquired in step S100.

Next, in step S104, the pre-processing unit 24 stores the plurality of pre-processed learning images obtained in step S102 in the learning data storage unit 26.

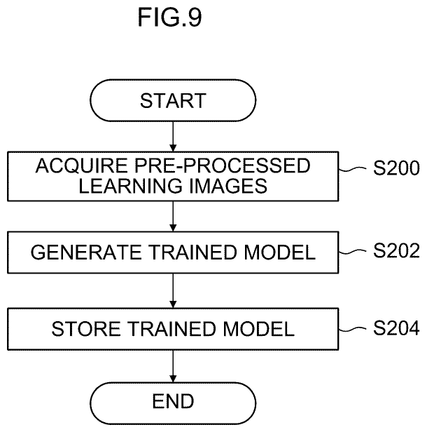

Next, the information processing device 10 executes trained model generation processing illustrated in FIG. 9.

In step S200, the learning acquisition unit 22 first reads a plurality of pre-processed learning images stored in the learning data storage unit 26 to acquire the plurality of pre-processed learning images.

In step S202, the trained model generation unit 28 trains a learning model so as to minimize the loss function L in the above Formula (D2) based on the plurality of pre-processed learning images acquired in step S200, and generates a trained model.

Next, in step S204, the trained model generation unit 28 stores the generated trained model in the trained model storage unit 30.

Since the trained model generation processing in FIG. 9 is executed, the trained model that outputs probabilities of shape categories to which a tongue belongs in response to an input of an image in which the tongue appears is generated, and a shape category of the tongue can be specified using the probabilities output from the trained model.

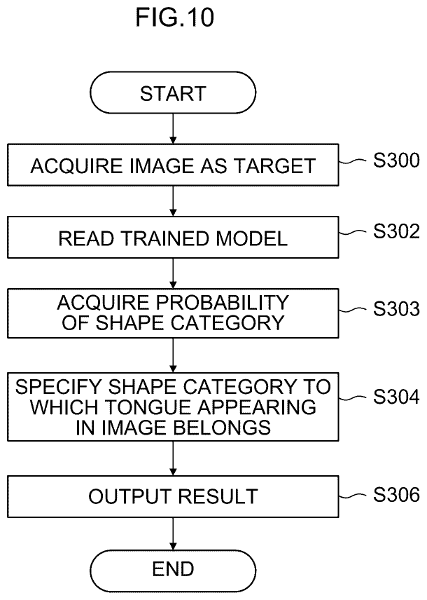

Next, when receiving a predetermined instruction signal, the information processing device 10 executes information processing illustrated in FIG. 10.

In step S300, the acquisition unit 32 acquires an image in which a tongue appears as a target.

In step S302, the specification unit 34 reads a trained model from the trained model storage unit 30.

In step S303, the specification unit 34 inputs the image acquired in step S300 to the trained model read in step S302 to acquire probabilities of shape categories output from the trained model.

In step S304, the specification unit 34 specifies a shape category of the tongue appearing in the image acquired in step S300 using the probabilities of the shape categories acquired in step S303.

In step S306, the output unit 36 outputs the shape category specified in step S306 as a result.

As described above, the information processing device 10 of the embodiment acquires a plurality of learning images in which a tongue of each of test subjects appears, the plurality of learning images being captured for each of the test subjects. The information processing device 10 trains a learning model by machine learning based on the plurality of learning images, thereby training the learning model such that a probability of the same shape category is the highest in a case in which learning images of the same test subject are input to the learning model at the time of generating a trained model that outputs probabilities of shape categories to which a tongue belongs in response to an input of an image in which the tongue appears. In addition, the information processing device 10 generates the trained model by training the learning model such that a variance of a probability distribution output from the learning model increases in a case in which each of a plurality of learning images of different test subjects is input to the learning model. As a result, a shape of the tongue can be classified from the image in which the tongue appears as a target even when it is difficult for a person to determine a shape category to which the tongue belongs.

In addition, the information processing device 10 trains the learning model such that the probability of the same shape category is the highest when the learning images of the same test subject are input to the learning model. Since information that test subjects are the same is used in this manner, the shape of the tongue can be classified even when it is difficult for the person to determine in advance the shape category to which the tongue belongs.

In addition, the information processing device 10 can classify the shape of the tongue more accurately by correcting an angle of the image in which the tongue appears. In addition, in the present embodiment, it is not necessary to perform homogenization by a dedicated instrument such as face fixation during image capturing, different from geometric classification of a tongue, and high determination performance can be achieved with comprehensive determination by machine learning. Specifically, it is possible to suppress variations in shapes on images depending on image capturing conditions.

In addition, as described above, the number of shape categories can be adjusted by adjusting the parameter ε. As a result, it is possible to set the number of shape categories that is optimal.

In addition, the use of the classification result of the shape of the tongue according to the present embodiment enables an application to preliminary screening of a disease state or health condition diagnosis in medical care, basic classification for an application to estimation of taste preference or the like, or classification for customization of a learning method for learning pronunciation of another language.

### EXAMPLES

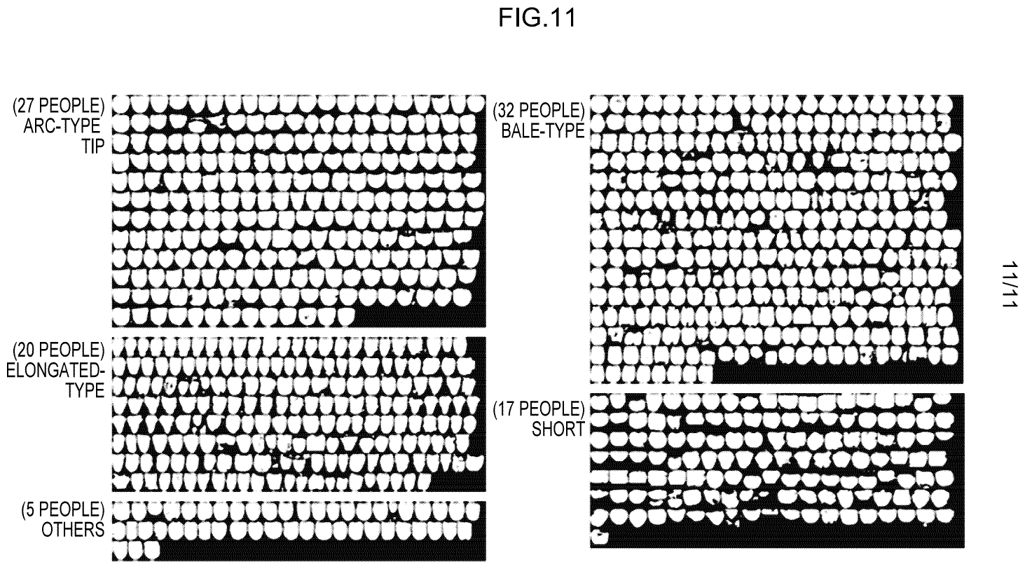

Next, examples corresponding to the above embodiment will be described. FIG. 11 illustrates a result of classifying shapes of tongues using a method according to the above embodiment. In FIG. 11, the shapes of the tongues are classified into five shape categories. Referring to FIG. 11, it can be seen that tongues having substantially similar shapes are classified into the same shape category.

Note that the technique of the disclosure is not limited to the above embodiment, and various modifications and applications can be made without departing from the gist of the disclosure.

For example, the embodiment in which the program is installed in advance has been described in the present specification, but the program can be provided by being stored in a computer-readable recording medium.

Note that the processing executed by the CPU reading software (program) in the above embodiment may be executed by various processors other than the CPU. Examples of the processors in this case include a programmable logic device (PLD) whose circuit configuration can be changed after manufacturing, such as a field-programmable gate array (FPGA), a dedicated electric circuit that is a processor having a circuit configuration exclusively designed for executing specific processing, such as an application specific integrated circuit (ASIC), and the like. Alternatively, a general-purpose graphics processing unit (GPGPU) may be used as the processor. In addition, each processing may be executed by one of the various processors, or may be executed by any combination of two or more processors of the same type or different types (for example, a plurality of FPGAs, a combination of a CPU and an FPGA, and the like). In addition, more specifically, a hardware structure of the various processors is an electric circuit in which circuit elements such as semiconductor elements are combined.

In addition, an aspect in which the program is stored (installed) in advance in a storage has been described in the above embodiment, but the invention is not limited thereto. The program may be provided in a form of being stored in a non-transitory storage medium such as a compact disk read only memory (CD-ROM), a digital versatile disk read only memory (DVD-ROM), or a universal serial bus (USB) memory. In addition, the program may be downloaded from an external device via a network.

In addition, each processing of the present embodiment may be configured by a computer, a server, or the like including a general-purpose arithmetic processing device, a storage device, and the like, and each processing may be executed by a program. This program is stored in the storage device, and can be recorded in a recording medium such as a magnetic disk, an optical disk, or a semiconductor memory, or can be provided through a network. Of course, any other constituent elements are not necessarily implemented by a single computer or server, and may be implemented in a distributed manner by a plurality of computers connected through a network.

In the above embodiment, a pair of a certain image and another image is obtained from the same test subject, and thus it is possible to implement appropriate classification for a problem that a boundary of categories is unknown using partial information on being classified into the same category. In the above embodiment, information indicating the same test subject is used as the partial information in a case in which a subject is a tongue, but information other than the test subject can also be utilized as partial information. Therefore, for example, the “same test subject” may be replaced with the “same individual or species”, and a “plurality of different test subjects” may be replaced with a “plurality of different individuals or species”. In addition, in the above embodiment, the case in which the subject as a target is a tongue has been described as an example, but the invention is not limited thereto. For example, the following modifications can be cited regarding the “individual or species” and the “subject” to which the present embodiment can be applied.

### First Modification

In the above embodiment, the case in which the subject is a human tongue and a shape of the tongue is classified has been described as an example, another part of a human body may be set as a subject. For example, the above embodiment may be applied to classification of a shape of a whole or a portion of a face, a shape of teeth, a shape of a hair portion (for example, a shape of baldness), or the like. In this case, for example, information that a pair of a certain image and another image is obtained from the same test subject is used as partial information.

For example, in the case of classifying a shape of a whole or a portion of the face, the above embodiment may be applied to classification of a shape of a shaped face part.

In addition, in the case of classifying a shape of a whole or a portion of the face, for example, the above embodiment can also be applied to an application in which an artificial tooth (for example, a mold guide) is created from a result of classification of the shape of the face.

In addition, in the case of classifying a shape of a whole or a portion of the face, for example, the above embodiment can also be applied to an application in which matching of eyeglasses that matches the shape of the whole or portion of the face.

### Second Modification

Alternatively, for example, a part inside a human body may be set as a subject. For example, the subject may be an organ, a tumor, or the like, and a shape of the organ, the tumor, or the like may be classified. In this case, for example, information that a pair of a certain image and another image is obtained from the same test subject is used as partial information. Alternatively, for example, information that a pair of a certain image and another image has been obtained from different test subjects suffering from the same disease can be used as partial information. A classification result of the shape of the organ, the tumor, or the like is useful information for performing various medical practices. Therefore, the technique of the present embodiment can also be a useful technique for performing a medical practice.

### Third Modification

Alternatively, for example, a body part of an animal may be set as a subject. For example, there is a case where a shape of a body part of an animal exhibits characteristics peculiar to a species or an individual of the animal. Therefore, for example, when a body part of a certain animal is set as a subject, it is possible to classify a shape of the body part of the animal using information regarding a species or an individual of the animal as partial information. A classification result of the shape of the body part of the animal is, for example, useful information for use in quality evaluation of meat of the animal or the like. For example, a classification result of a shape of a tongue of a cow (so-called beef tongue) reflects information regarding a species of the cow, and it is also possible to specify a species of a cow from a classification result of a shape of a beef tongue. Therefore, the information processing device 10 of the present embodiment can also be applied to, for example, a technique for preventing forgery of a breed.

### Fourth Modification

Alternatively, for example, a fruit or a vegetable may be used as a subject. For example, the quality based on a shape of a fruit or a vegetable may be automatically evaluated by classifying the shape of the fruit or vegetable. Therefore, for example, when a certain fruit or vegetable is set as a subject, it is possible to classify a shape of the fruit or vegetable using information regarding a species or an individual of the fruit or vegetable as partial information.

### Fifth Modification

Alternatively, for example, a part of a human body may be set as a subject, and a temporal change of the part may be detected. In this case, the information processing device 10 sets, for example, a face, a tongue, teeth, hair, or the like as a subject, and detects a change in a shape of the part. For example, if a shape of a body part of a certain test subject is classified into Category 2 at a current time point even though the shape of the body part of the test subject had been classified into Category 1 until a certain time point in the past, it means that the shape of the body part has changed with time. Therefore, for example, a temporal change of a body part of a test subject can be detected by capturing an image of the body part every time predetermined time or a predetermined period elapses and classifying a shape of the body part appearing in the image. For example, as an application destination, this modification can also be used for dental applications or the like for detecting a state change in an oral cavity. In addition, for example, this modification can also be used for the purpose of detecting a deterioration of a whole or a portion of a face. Note that, in the case of using this modification, it is necessary to train a learning model using partial information indicating that short-period images whose temporal change can be considered to be sufficiently small are classified into the same category at the stage of training the learning model.

### Sixth Modification

Alternatively, for example, a face of a person may be classified as a subject, and a facial expression appearing on the face of the person may be classified as a shape category. An emotion appears on the facial expression of the person. Therefore, for example, it is also possible to classify facial expressions caused by similar emotions using information that both a certain test subject A and another test subject B have experienced the same voice, sentence, video, or the like as partial information. For example, a facial expression when the test subject A hears a sentence X (for example, abusive language) and a facial expression when the test subject B hears the sentence X should be classified into the same category. As a result, for example, it is possible to classify a target such as a facial expression of a person whose boundary is ambiguous. In addition, when the facial expression of the person is classified, it is also possible to classify a target such as an emotion whose boundary is ambiguous.

In addition, the use of classification results of shapes of various body parts enables an application to preliminary screening of a disease state or health condition diagnosis in medical care, basic classification for an application to estimation of taste preference or the like, or classification for customization of a learning method for learning pronunciation of another language.

In addition, the case in which the information processing device 10 executes the trained model generation processing in FIG. 9 and the information processing in FIG. 10 has been described as an example in the above embodiment, but the invention is not limited thereto. For example, a trained model generation device may execute the trained model generation processing in FIG. 9, and an information processing device may execute the information processing in FIG. 10. In this case, the trained model generation device includes at least the learning acquisition unit 22 and the trained model generation unit 28. In addition, in this case, the information processing device includes at least the acquisition unit 32 and the specification unit 34.

All cited documents, patent applications, and technical standards mentioned in the present specification are incorporated by reference in the present specification to the same extent as if the individual cited document, patent application, or technical standard was specifically and individually indicated to be incorporated by reference.

### Supplementary Notes

Aspects of the disclosure will be added hereinafter.

### Supplementary Note 1

A trained model generation device including:
a learning acquisition unit that acquires a plurality of learning images in which a subject that is a part of each of individuals or species appears, the plurality of learning images being captured for each of the individuals or species; and
a trained model generation unit that trains a learning model by machine learning based on the plurality of learning images to generate a trained model that outputs a probability of a shape category to which the subject belongs in response to an input of an image in which the subject appears,
the trained model being generated by training the learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

### Supplementary Note 2

The trained model generation device according to Supplementary Note 1, wherein
the trained model generation unit generates the trained model so as to decrease first entropy that is indicated by the following Formula (A) and related to a probability yᵢ of an i-th shape category output from the learning model,
decrease second entropy that is indicated by the following Formula (B) and is cross-entropy between the probability yᵢ of the i-th shape category output when a first learning image in which the subject of a first individual or species appears is input to the learning model and a probability yᵢ' of the i-th shape category output when a second learning image in which the subject of the first individual or species appears is input to the learning model, and
increase third entropy that is indicated by the following Formula (C) and related to a sample average <yᵢ>of the probabilities yᵢ of the i-th shape category output when each of the plurality of learning images is input to the learning model.

$$\begin{matrix}[ Mathematical Expression 6 ] & \\ - {\sum }_{i} {y}_{i} ln {y}_{i} & ( A )\end{matrix}$$

$$- {\sum }_{i} {{y}_{i}}^{′} ln {y}_{i} \qquad ( B )$$

$$- {\sum }_{i} 〈 {y}_{i} 〉 ln 〈 {y}_{i} 〉 \qquad ( C )$$

### Supplementary Note 3

The trained model generation device according to Supplementary Note 2, wherein the trained model generation unit generates the trained model so as to decrease a loss function L indicated by the following Formula (D1) obtained by integrating the Formulas (A), (B), and (C):

$$\begin{matrix}[ Mathematical Expression 7 ] & \\ L = {〈 - {\sum }_{i} ( {y}_{i} + {{y}^{′}}_{i} ) ln {y}_{i} 〉}_{b} + ( - ln ( 1 / n ) + {\sum }_{i} {〈 {y}_{i} 〉}_{b} ln {〈 {y}_{i} 〉}_{b} ) & ( D1 )\end{matrix}$$

where, b represents a mini-batch that is an image set selected from a plurality of learning images, <>_{b} represents a sample average of probabilities of shape categories of learning images included in the mini-batch, and n represents the number of shape categories.

### Supplementary Note 4

The trained model generation device according to Supplementary Note 2, wherein the trained model generation unit generates the trained model so as to decrease a loss function L indicated by the following Formula (D2) obtained by integrating the Formulas (A), (B), and (C):

$$\begin{matrix}[ Mathematical Expression 8 ] & \\ L = {〈 - {\sum }_{i} ( {y}_{i} + {{y}^{′}}_{i} ) ln {y}_{i} 〉}_{b} + max ( - εln ( 1 / n ) + {\sum }_{i} {〈 {y}_{i} 〉}_{b} ln {〈 {y}_{i} 〉}_{b} , 0 ) & ( D2 )\end{matrix}$$

where, b represents a mini-batch that is an image set selected from a plurality of learning images, <>_{b} represents a sample average of probabilities of shape categories of learning images included in the mini-batch, n represents the number of shape categories, and ε is a parameter of 1 or less.

### Supplementary Note 5

An information processing device including:
an acquisition unit that acquires an image in which a subject appears as a target; and
a specification unit that inputs the image acquired by the acquisition unit to a trained model generated in advance to acquire probabilities of shape categories output from the trained model, and specifies a shape category to which the subject appearing in the image belongs using the probabilities,
wherein the trained model is the trained model that outputs a probability of the shape category to which the subject appearing in the image belongs in response to the input of the image in which the subject appears, and
the trained model is the trained model obtained by training a learning model such that the probability of the same shape category is the highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

### Supplementary Note 6

A trained model generation method causing a computer to execute processing, the processing including:
acquiring a plurality of learning images in which a subject that is a part of each of individuals or species appears, the plurality of learning images being captured for each of the individuals or species; and
training a learning model by machine learning based on the plurality of learning images to generate a trained model that outputs a probability of a shape category to which the subject belongs in response to an input of an image in which the subject appears,
the trained model being generated by training the learning model such that the probability of the same shape category is highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

### Supplementary Note 7

An information processing method causing a computer to execute processing, the processing including:
acquiring an image in which a subject appears as a target; and
inputting the acquired image to a trained model generated in advance to acquire probabilities of shape categories output from the trained model, and specifying a shape category to which the subject appearing in the image belongs using the probabilities,
wherein the trained model is the trained model that outputs a probability of the shape category to which the subject appearing in the image belongs in response to the input of the image in which the subject appears, and
the trained model is the trained model obtained by training a learning model such that the probability of the same shape category is highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

### Supplementary Note 8

A trained model generation program for causing a computer to execute processing, the processing including:
acquiring a plurality of learning images in which a subject that is a part of each of individuals or species appears, the plurality of learning images being captured for each of the individuals or species; and
training a learning model by machine learning based on the plurality of learning images to generate a trained model that outputs a probability of a shape category to which the subject belongs in response to an input of an image in which the subject appears,
the trained model being generated by training the learning model such that the probability of the same shape category is highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

### Supplementary Note 9

An information processing program for causing a computer to execute processing, the processing including:
acquiring an image in which a subject appears as a target; and
inputting the acquired image to a trained model generated in advance to acquire probabilities of shape categories output from the trained model, and specifying a shape category to which the subject appearing in the image belongs using the probabilities,
wherein the trained model is the trained model that outputs a probability of the shape category to which the subject appearing in the image belongs in response to the input of the image in which the subject appears, and
the trained model is the trained model obtained by training a learning model such that the probability of the same shape category is highest in a case in which learning images in which the subjects of the same individual or species appear are input to the learning model, and by training the learning model such that a variance of a probability distribution output from the learning model increases in a case in which each of learning images in which the subjects of a plurality of different individuals or species appear is input to the learning model.

What is claimed is:

1. A trained model generation device comprising a memory and a processor connected to the memory,
wherein the processor is configured to:
acquire a plurality of learning images in which a subject that is a part of each of individuals or species appears, the plurality of learning images being captured for each of the individuals or species; and
train a learning model by machine learning based on the plurality of learning images to generate a trained model that outputs a probability of a shape category to which the subject belongs in response to an input of an image in which the subject appears, the trained model being generated by training the learning model such that the probability of an identical shape category is highest in a case in which learning images in which the subjects of an identical individual or species appear are input to the learning model, and by training the learning model such that a variance of a probability distribution output from the learning model increases in a case in which each of learning images in which the subjects of a plurality of different individuals or species appear is input to the learning model.

2. The trained model generation device according to claim 1, wherein the processor is configured to generate the trained model in such a manner as to:
decrease first entropy that is indicated by the following Formula (A) and related to a probability yᵢ of an i-th shape category output from the learning model,
decrease second entropy that is indicated by the following Formula (B) and is cross-entropy between the probability yᵢ of the i-th shape category output when a first learning image in which the subject of a first individual or species appears is input to the learning model and a probability yᵢ' of the i-th shape category output when a second learning image in which the subject of the first individual or species appears is input to the learning model, and
increase third entropy that is indicated by the following Formula (C) and related to a sample average <yᵢ>of the probabilities yᵢ of the i-th shape category output when each of the plurality of learning images is input to the learning model,
$$- {\sum }_{i} {y}_{i} ln {y}_{i} \qquad ( A )$$
$$- {\sum }_{i} {{y}_{i}}^{′} ln {y}_{i} \qquad ( B )$$
$$- {\sum }_{i} 〈 {y}_{i} 〉 ln 〈 {y}_{i} 〉 . \qquad ( C )$$

3. The trained model generation device according to claim 2, wherein the processor is configured to generate the trained model in such a manner as to decrease a loss function L indicated by the following Formula (D1) obtained by integrating the Formulas (A), (B), and (C):
$$L = {〈 - {\sum }_{i} ( {y}_{i} + {{y}^{′}}_{i} ) ln {y}_{i} 〉}_{b} + ( - ln ( 1 / n ) + {\sum }_{i} {〈 {y}_{i} 〉}_{b} ln {〈 {y}_{i} 〉}_{b} ) \qquad ( D1 )$$
wherein, b represents a mini-batch that is an image set selected from the plurality of learning images, <>_{b} represents a sample average of probabilities of shape categories of learning images included in the mini-batch, and n represents a number of the shape categories.

4. The trained model generation device according to claim 2, wherein the processor is configured to generate the trained model in such a manner as to decrease a loss function L indicated by the following Formula (D2) obtained by integrating the Formulas (A), (B), and (C):
$$L = {〈 - {\sum }_{i} ( {y}_{i} + {{y}^{′}}_{i} ) ln {y}_{i} 〉}_{b} + max ( - εln ( 1 / n ) + {\sum }_{i} {〈 {y}_{i} 〉}_{b} ln {〈 {y}_{i} 〉}_{b} , 0 ) \qquad ( D2 )$$
wherein, b represents a mini-batch that is an image set selected from the plurality of learning images, <>_{b} represents a sample average of probabilities of shape categories of learning images included in the mini-batch, n represents a number of the shape categories, and ε is a parameter of 1 or less.

5. An information processing device comprising a memory and a processor connected to the memory,
wherein the processor is configured to:
acquire an image in which a subject appears as a target; and
input the acquired image to a trained model generated in advance, to acquire probabilities of shape categories output from the trained model, and specify a shape category to which the subject appearing in the image belongs using the probabilities,
wherein the trained model is a trained model that outputs a probability of the shape category to which the subject appearing in the image belongs in response to the input of the image in which the subject appears, and
wherein the trained model is a trained model obtained by training a learning model such that the probability of an identical shape category is highest in a case in which learning images in which the subjects of an identical individual or species appear are input to the learning model, and by training the learning model such that a variance of a probability distribution output from the learning model increases in a case in which each of learning images in which the subjects of a plurality of different individuals or species appear is input to the learning model.

6. A trained model generation method comprising:
acquiring, by a processor, a plurality of learning images in which a subject that is a part of each of individuals or species appears, the plurality of learning images being captured for each of the individuals or species; and
training, by the processor, a learning model by machine learning based on the plurality of learning images to generate a trained model that outputs a probability of a shape category to which the subject belongs in response to an input of an image in which the subject appears, the trained model being generated by training the learning model such that the probability of an identical shape category is highest in a case in which learning images in which the subjects of an identical individual or species appear are input to the learning model, and by training the learning model such that a variance of a probability distribution output from the learning model increases in a case in which each of learning images in which the subjects of a plurality of different individuals or species appear is input to the learning model.

7. An information processing method comprising:
acquiring, by a processor, an image in which a subject appears as a target; and
inputting, by the processor, the acquired image to a trained model generated in advance, to acquire probabilities of shape categories output from the trained model, and specifying a shape category to which the subject appearing in the image belongs using the probabilities,
wherein the trained model is a trained model that outputs a probability of the shape category to which the subject appearing in the image belongs in response to the input of the image in which the subject appears, and
wherein the trained model is a trained model obtained by training a learning model such that the probability of an identical shape category is highest in a case in which learning images in which the subjects of an identical individual or species appear are input to the learning model, and by training the learning model such that a variance of a probability distribution output from the learning model increases in a case in which each of learning images in which the subjects of a plurality of different individuals or species appear is input to the learning model.

8. A non-transitory recording medium in which a trained model generation program is recorded, the trained model generation program being executable by a processor to perform processing comprising:
acquiring a plurality of learning images in which a subject that is a part of each of individuals or species appears, the plurality of learning images being captured for each of the individuals or species; and
training a learning model by machine learning based on the plurality of learning images to generate a trained model that outputs a probability of a shape category to which the subject belongs in response to an input of an image in which the subject appears, the trained model being generated by training the learning model such that the probability of an identical shape category is highest in a case in which learning images in which the subjects of an identical individual or species appear are input to the learning model, and by training the learning model such that a variance of a probability distribution output from the learning model increases in a case in which each of learning images in which the subjects of a plurality of different individuals or species appear is input to the learning model.

9. A non-transitory recording medium in which an information processing program is recorded, the information processing program being executable by a processor to perform processing comprising:
acquiring an image in which a subject appears as a target; and
inputting the acquired image to a trained model generated in advance, to acquire probabilities of shape categories output from the trained model, and specifying a shape category to which the subject appearing in the image belongs using the probabilities,
wherein the trained model is a trained model that outputs a probability of the shape category to which the subject appearing in the image belongs in response to the input of the image in which the subject appears, and
wherein the trained model is a trained model obtained by training a learning model such that the probability of an identical shape category is highest in a case in which learning images in which the subjects of an identical individual or species appear are input to the learning model, and by training the learning model such that a variance of a probability distribution output from the learning model increases in a case in which each of learning images in which the subjects of a plurality of different individuals or species appear is input to the learning model.
